(19) United States
(12) Patent Application Publication
(10) Pub. No.: US 2015/0293684 A1
(43) Pub. Date: Oct. 15, 2015

(54) METHOD FOR CONTROLLING APPS ACTIVATION WITHIN LOCAL NETWORK

(71) Applicant: SCREENOVATE TECHNOLOGIES LTD., Ra'anana (IL)

(72) Inventors: Joshua GLAZER, Ra'anana (IL); Matan SHAPIRA, Tel Aviv (IL)

(21) Appl. No.: 14/683,344

(22) Filed: Apr. 10, 2015

Related U.S. Application Data
(60) Provisional application No. 61/977,710, filed on Apr. 10, 2014.

(51) Int. Cl. G06F 3/0484; G06F 3/041; H04L 29/06

(52) U.S. Cl. CPC G06F 3/04847; H04L 65/4092; G06F 3/04842; G06F 3/041

(57) ABSTRACT

The present invention provides a method for controlling apps activation within local network having at least one receiver module associated with external screen and at least one touch enabled device, both enabled to activate multimedia streaming applications. The method comprising the steps of: selecting between at least one receiver module and at least one touch enabled device for activating multimedia application selected by a user, based on predefined rules or user instruction. In case the selected device is not a mobile device having touched enabled screen:reverse mirroring of activated multimedia applications from the receiver module of the selected device to the touch enabled device through direct local wireless communication network and conveying input data from the touch enabled device in real-time to the receiver module of the selected device through direct local wireless communication network.

### TECHNICAL FIELD

The present invention relates to the field of multimedia interface management, and more particularly, to mirroring multimedia interface and application between two different computerized communication devices.

### SUMMARY OF INVENTION

The present invention provides a method for controlling apps activation within local network having at least one receiver module associated with external screen and at least one touch enabled device, both enabled to activate multimedia streaming applications. The method comprising the steps of: selecting between at least one receiver module and at least one touch enabled device for activating multimedia application selected by a user, based on predefined rules or user instruction. In case the selected device is not a mobile device having touched enabled screen:reverse mirroring of activated multimedia applications from the receiver module of the selected device to the touch enabled device through direct local wireless communication network and conveying input data from the touch enabled device in real-time to the receiver module of the selected device through direct local wireless communication network.

The present invention provides a method for controlling apps activation within local network having at least one receiver module associated with external screen and at least one touch enabled device, both enabled to activate multimedia streaming applications. The method comprising the steps of: selecting between at least one receiver module and at least one touch enabled device for activating multimedia, application or content selected by a user, based on predefined rules or user instruction,

in case the selected device is not a mobile device having touched enabled screen:reverse mirroring of activated multimedia applications from the receiver module of the selected device to the touch enabled device through direct local wireless communication network and conveying input data from the touch enabled device in real-time to the receiver module of the selected device through direct local wireless communication network.

The method of claim 1 further comprising the step of transmitting the identification the multimedia content to be activated from touch enabled device to the receiver module.

According to some embodiments of the present invention the method further comprising the step of transmitting the identification the required multimedia application to be activated from touch enabled device to the receiver module.

According to some embodiments of the present invention the method further comprising the step of transmitting the multimedia application binary data to be activated from touch enabled device to the receiver module.

According to some embodiments of the present invention the method further comprising the step of installing the multimedia application on the receiver module

According to some embodiments of the present invention the method further comprising the step of transmitting the identification the multimedia content to be activated from the receiver module to the touch enabled device.

According to some embodiments of the present invention the method further comprising the step of transmitting the identification of the required multimedia application to be activated from the receiver module to the touch enabled device.

According to some embodiments of the present invention the method of further comprising the step of transmitting the multimedia application binary data to be activated from the receiver module to the touch enabled device.

According to some embodiments of the present invention the predefined rules for selecting the available device for activating multimedia application, include checking video streaming quality.

According to some embodiments of the present invention the predefined rules for selecting the available device for activating multimedia application, include identifying the use case of the application and the type of content.

The present invention provides a system for controlling apps activation within local network having at least one receiver module associated with external screen and at least one touch enabled device, both enabled to activate multimedia streaming applications. The comprised of switching module for selecting between at least one receiver module and at least one touch enabled device for activating multimedia application or content selected by a user, based on predefined rules or user instruction.

In case the selected device is not a mobile device having touched enabled screen:activating mirroring module for reverse mirroring of activated multimedia applications from the receiver module of the selected device to the touch enabled device through direct local wireless communication network and conveying input data from the touch enabled device in real-time to the receiver module of the selected device through direct local wireless communication network.

According to some embodiments of the present invention the switching further comprising the step of transmitting the identification the multimedia content to be activated from touch enabled device to the receiver module.

According to some embodiments of the present invention the switching further comprising the step of transmitting the identification the required multimedia application to be activated from touch enabled device to the receiver module.

According to some embodiments of the present invention the switching further comprising the step of transmitting the multimedia application binary data to be activated from touch enabled device to the receiver module.

According to some embodiments of the present invention the switching further comprising the step of installing the multimedia application on the receiver module

According to some embodiments of the present invention the switching further comprising the step of transmitting the identification the multimedia content to be activated from the receiver module to the touch enabled device.

According to some embodiments of the present invention the switching further comprising the step of transmitting the identification of the required multimedia application to be activated from the receiver module to the touch enabled device.

According to some embodiments of the present invention the switching further comprising the step of transmitting the multimedia application binary data to be activated from the receiver module to the touch enabled device.

According to some embodiments of the present invention the predefined rules for selecting the available device for activating multimedia application, include checking video streaming quality.

According to some embodiments of the present invention the predefined rules for selecting the available device for activating multimedia application, include identifying the use case of the application and the type of content.

These, additional, and/or other aspects and/or advantages of the present invention are: set forth in the detailed description which follows; possibly inferable from the detailed description; and/or learnable by practice of the present invention.

### BRIEF DESCRIPTION OF DRAWINGS

FIG. 1 is a block diagram of the system components and modules, according to some embodiments of the invention;

FIG. 2 shows the display screen on the touch enabled device and on an external screen, according to some embodiments of the invention;

FIG. 3 is a flowchart illustrating mirroring module activities providing full mirroring of the receiver device, according to some embodiments of the invention; and

FIG. 4 is a flowchart illustrating mirroring module activities providing full mirroring of the receiver device, according to some embodiments of the invention.

FIG. 5 is a flowchart illustrating interaction module activities providing full mirroring of the receiver device, according to some embodiments of the invention.

### MODES FOR CARRYING OUT THE INVENTION

In the following detailed description of various embodiments, reference is made to the accompanying drawings that form a part thereof, and in which are shown by way of illustration specific embodiments in which the invention may be practiced. It is understood that other embodiments may be utilized and structural changes may be made without departing from the scope of the present invention.

The term “touch enabled device” as used herein in this application, is defined as a mobile device having a touch screen with capability of running applications as well as streaming multimedia data to a screen that is external to the computerized mobile device (e.g. a mobile phone or a tablet device).

The term “receiver module” as used herein in this application, is defined as a processing communication module embedded in a dongle device or integrated in external screen such as TV or monitor device which support managing activating and streaming multimedia application.

The term “multimedia application” as used herein in this application, is defined as application which generate images, video or sound objects, such as video application, gaming application, chatting application or advertising.

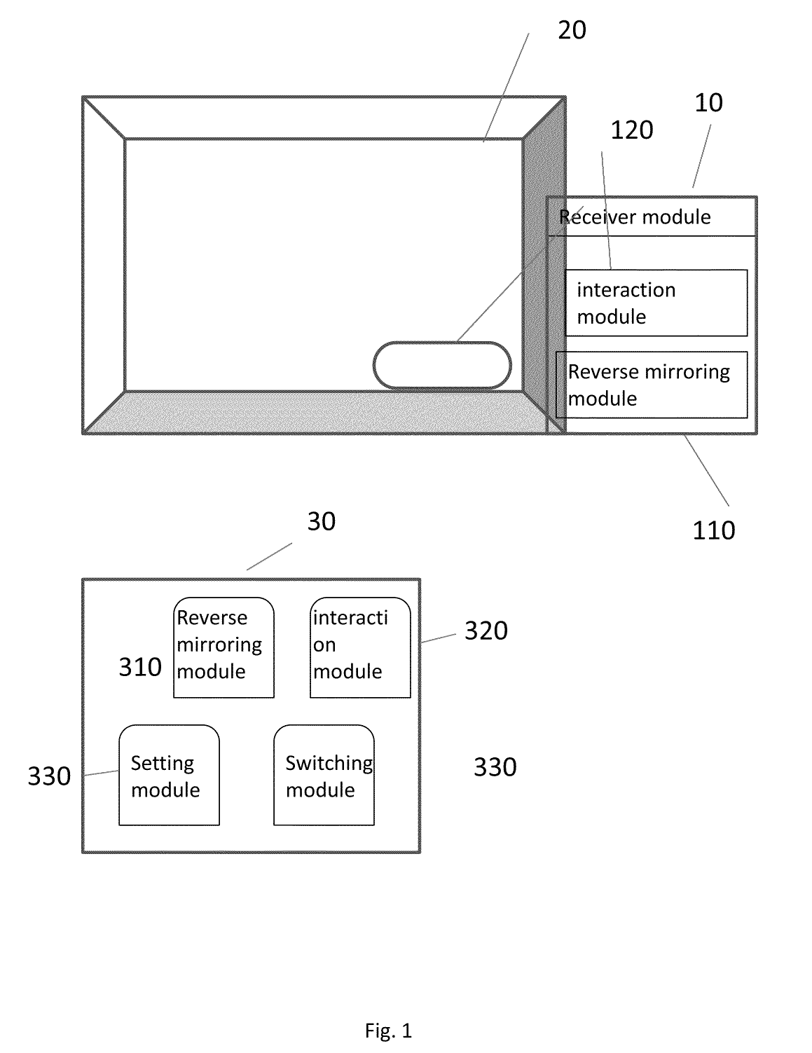

FIG. 1 is a block diagram of the system components and modules, according to some embodiments of the invention. The system of the present invention includes a receiver module 10 which embedded in a dongle device or integrated in external screen such as TV or monitor device. The receiver module 10 interacts with a touch enabled device, which is designated to function as interface device for the receiver module for managing multimedia applications. This interfacing interaction is enabled by mirroring modules 110, 310 for streaming back the interface of the receiver module and the running application to the touch enabled device, these modules can be implemented, partly at the receiver module or the touch enabled device or partly at the touch enabled device. Interaction modules 120, 130 support conveying input data and sensor data from the touch enabled device, to the receiver module to enable full interface functionality. These interaction modules can be implemented, partly at the receiver module or the touch enabled device or partly at the touch enabled device.

According to some embodiments of the present invention the reviver module and touch enabled device are communication through direct local wireless network such as WIFI direct, or Bluetooth. Optionally the devices are connected though global wireless or wired network using cellular network or the Internet.

According to some embodiments of the present invention it is suggested to provide switching module 340 at the touch enabled device, to enable dynamic switching of interface and activation control between at least one touch enable device and receiver module.

According to some embodiments of the present invention it is suggested to provide switching module 340 at the receiver module, to enable dynamic switching of interface and activation control between at least one touch enable device and receiver module.

Optionally the switching module may be implemented partly on the mobile device and partly at the receiver module.

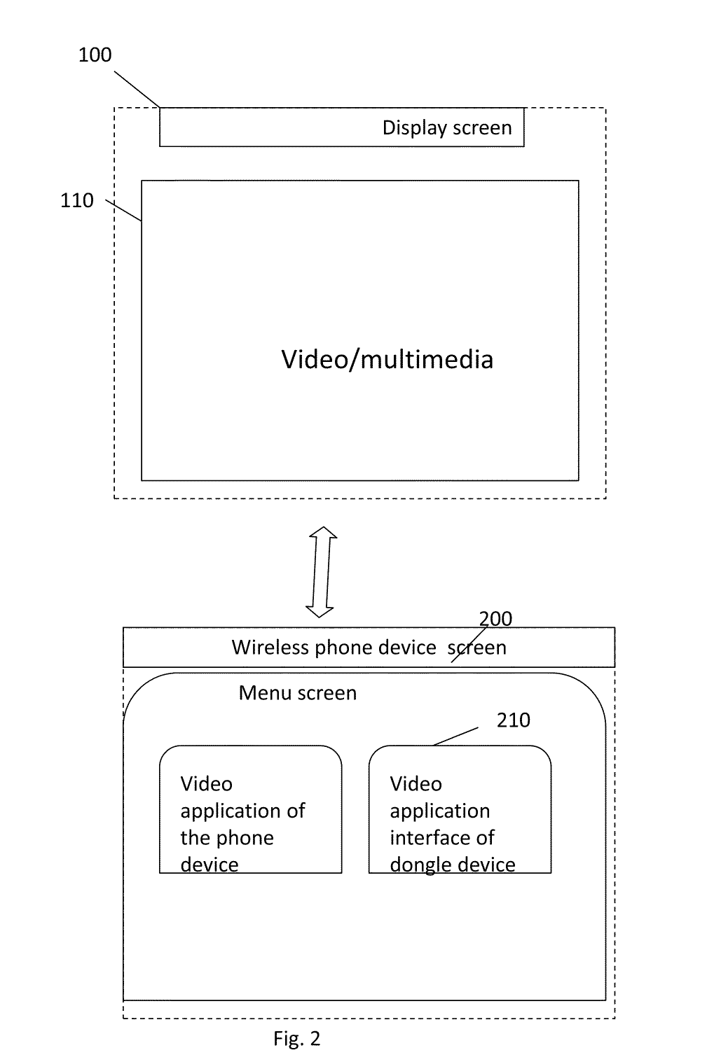

FIG. 2 shows the display screens on the touch enabled device and on an external screen, according to some embodiments of the invention.

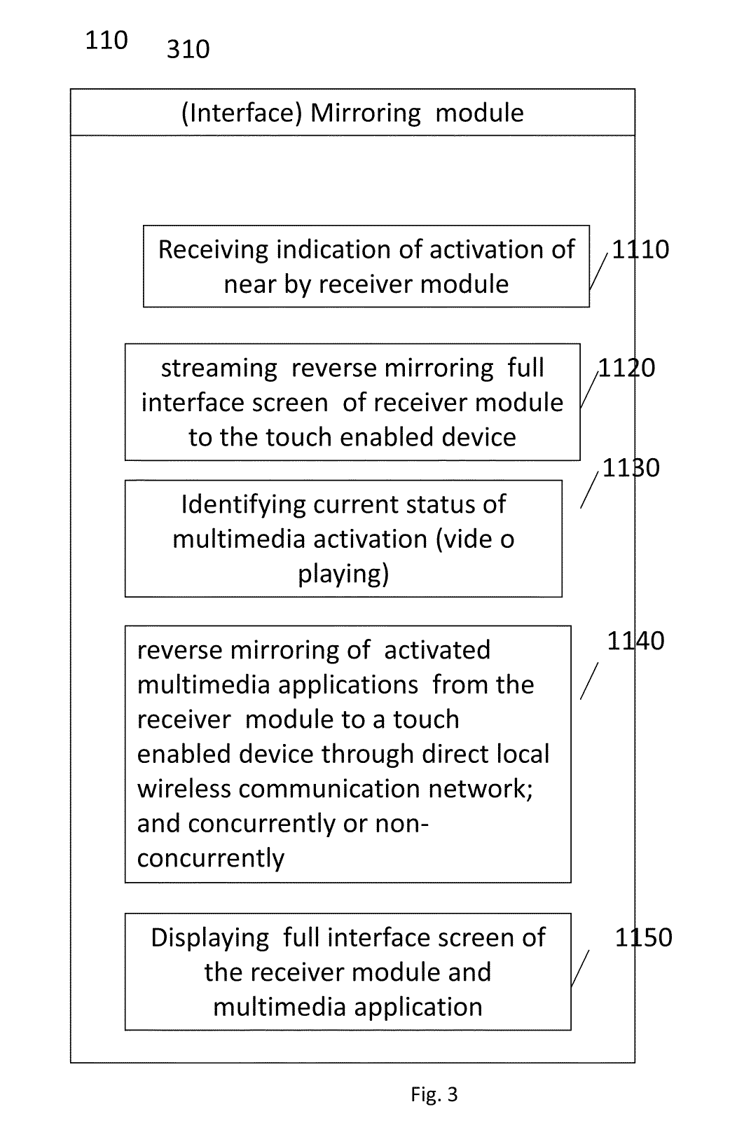

FIG. 3 is a flowchart illustrating mirroring module activities providing full mirroring of the receiver device, according to some embodiments of the invention. The mirroring module functioning as a full interface, implements at least one of the following steps: Receiving indication of activation of nearby receiver module (step 1110), streaming reverse mirroring full interface screen of receiver module to the touch enabled device (step 1120), identifying current status of multimedia activation (e.g. video starts playing) (step 1130), reverse mirroring of activated multimedia applications from the receiver module to a touch enabled device through direct local wireless communication network, concurrently or non-concurrently (step 1140) and/or displaying full interface screen of the receiver module and multimedia application (step 1150) including full movie video stream or gaming video. The reverse mirroring may be implemented by WIFI direct protocols or optionally using global communication network such as TCP/IP.

The full mirroring stream from the receiver to touch enabled device include: audio stream:audio being played on the receiver is being transmitted to the touch enabled device, and played on it.

Video stream: Entire video content being displayed on the receiver device internal display is being transmitted to the touch enabled device, and displayed on it.

The full mirroring stream from touch enabled device to the receiver may further include:

Sensor information: all input being received from sensors (Touch screen input, Gyroscope movement, Accelerometer input) is being transmitted to the receiver, which process the input as if the actions detected by the sensors were performed on the receiver itself.

Peripheral information: all input generated by external devices such as printers, speakers etc. connected to the touch enabled device (e.g. via HCl Host Controller Interface) are transmitted to the receiver and processed by receiver, as if these devices were actually connected to that receiver.

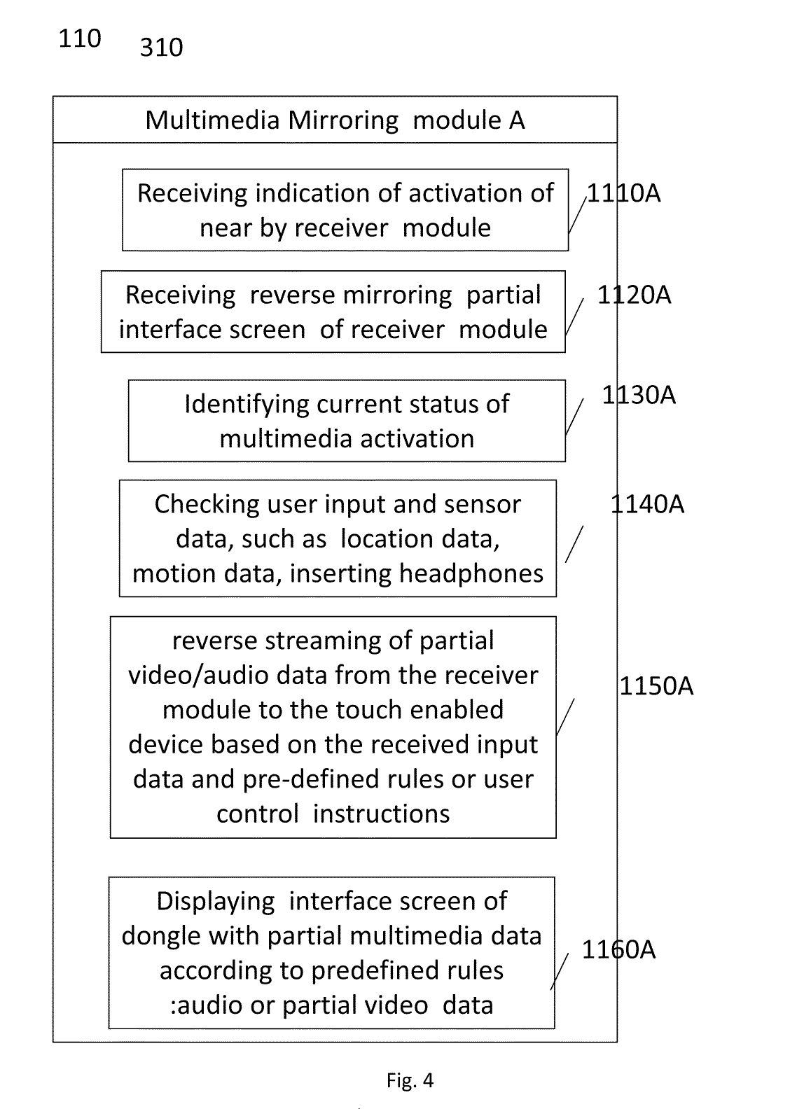

FIG. 4 is a flowchart illustrating mirroring module activities providing partial mirroring of the receiver device, according to some embodiments of the invention. The mirroring module functioning as partial dynamic interface, implements at least one of the following steps: receiving indication of activation of nearby receiver module (step 1110A), receiving reverse mirroring of partial interface screen of receiver module (step 1120A), identifying current status of multimedia activation (step 1130A), checking user input and measured sensor data of the touch enabled device, such as location data, motion data or inserting headphones (step 1140A), reverse streaming of partial video/audio data from the receiver module to the touch enabled device based on the received input data and pre-defined rules or user control instructions (step 1150A) and/or displaying interface screen of the receiver module with partial multimedia data according to predefined rules 1160. The predefined rules may relate to different scenarios when using multimedia application such video and gaming application. One scenario may define to include only control functionality (e.g. pause, play) of a video application, while the video itself is displayed only on the external screen. In the same scenario it may be defined to check the location of the touch enabled device using GPS sensor embedded within the touch enabled device, incase identifying the user walked away from the external screen, based on the predefined rules it is instructed to include the video itself to be displayed on the touch enabled device, enabling the user keep viewing the streamed video when leaving the area where the external screen is not visible. According to a second scenario, it is defined to identify connection of headphone to the touch enabled device, in such case predefined rules instruct the audio stream of a video currently running on receiver to be conveyed to the touch display device. According to a third scenario, the touch enabled device is enabled to display movie subtitles, not appearing at the external display.

Basic Scenarios Uses Cases

1. Sending only audio from the dongle to the device—this can be used when watching a movie on the dongle, while listening to ifs audio track using headphones connected to the hand held device.

2. Sending the screen of a video player application, while dropping the video part of the display (i.e. showing a placeholder image where the movie would have been), thus transmitting only the relevant information for control needs.

3. Decreasing video stream parameters (Decreasing bitrate, frame rate or resolution) of the receiver's display, thus transferring a complete look & feel of the receiver screen, while requiring less network bandwidth.

Implementations examples of use cases:

1. Identifying new connection to headset (or earphones)—upon identification a pre-defined rule, determines only audio is transmitted back to the device.

2. In case if Identifying Video playback session the pre-defined rule determine audio is not transmitted at all and video is removed from the screen and preforming degradation of streaming quality of control interface as the user experience will not be affected much by degrading the frame rate of the UI elements motion.

3. Incase of games playing session the pre-defined rule determines to decrease the video parameters, while sending all sensor information to the dongle.

4. Incase of Static applications, according to the predefined rules identifying the user shows a mostly static information (e.g. showing a picture slideshow), decreasing the frame rate significantly (while increasing the bit rate) to provide a crisp picture, while taking the consideration the fact that there is no need for smooth movement at the time.

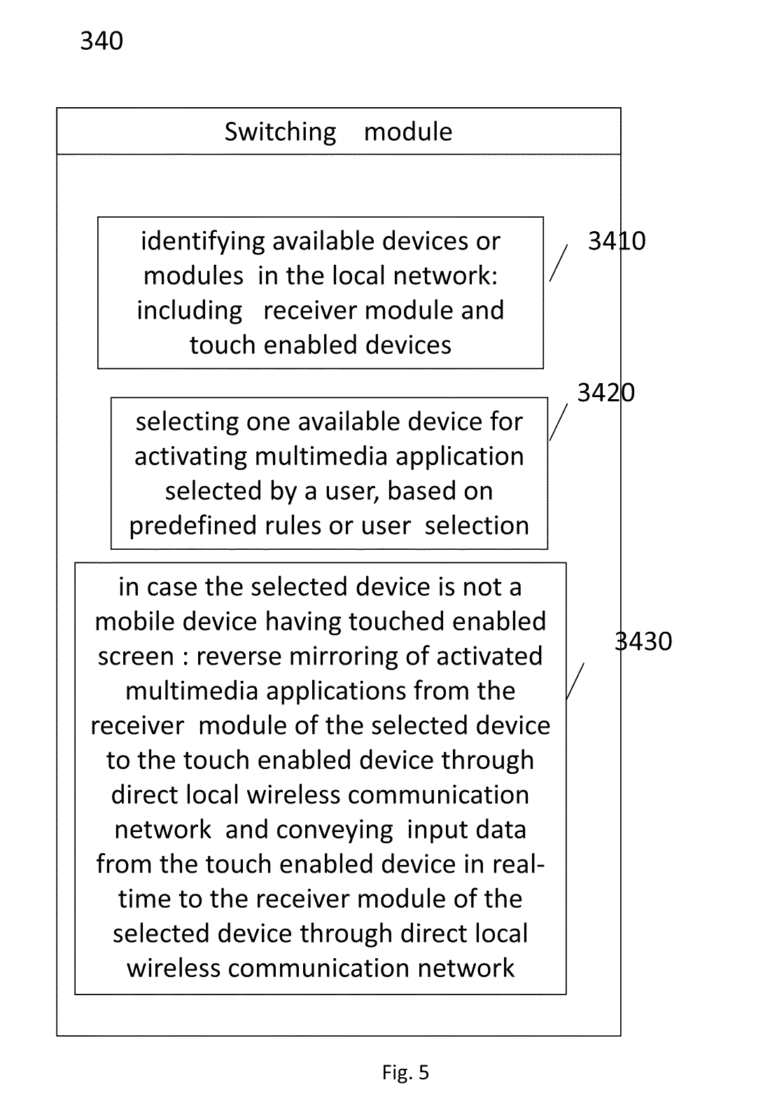

FIG. 5 is a flowchart illustrating switching module activities providing switching control between the receiver device and the touch enabled device, according to some embodiments of the invention. The switching modules implements at least one of the following steps: identifying available devices in the local network (step 3410), selecting one available device for activating multimedia application or content selected by a user, based on predefined rules or user selection (step 3420), in case the selected device is not a mobile device having touched enabled screen:reverse mirroring of activated multimedia applications from the receiver module of the selected device to at least one, touch enabled device through direct local wireless communication network and conveying input data from the touch enabled device in real-time to the receiver module of the selected device through direct local wireless communication network (step 3430). There are two scenarios when implementing the switching module. According the first scenario the user is using the touch enabled device as the primary device and the remote screen as display. In such scenario the mobile touch enabled device should transmit at least the identification of the selected content or/and the identification of the required application for running the content. In case the required application is not installed on the receiver device the required application binary data is conveyed to the receiver enabling to run the application on the receiver module.

According to second scenario the primary device is the receiver module using reverse mirroring technique as described above for displaying full or partial image/data of the multimedia content on the screen. In such scenarios, the information of the selected content and/or required application, is transmitted from the receiver module to the touch enabled mobile device.

In case the required application is not installed on the mobile touch enabled device, the required application binary data is conveyed to the receiver enabling to run the application on the mobile touch enabled device.

Optionally the rules for selecting the available device for activating multimedia application, take into account the video streaming quality, for example if the user initiated to activate video application on the touch enabled device, it may be defined to switch the activation to the receiver module, as, the streaming between the touch enabled device and the receiving module may impact the video quality.

According to embodiments of the present invention, the switching module is implemented when the user use his smart phone device as the primary device, using remote screen as display. While surfing or using different application the switching modules apply the predefined rules for identifying the use case of the application and the type of content, such text, images, video etc. Based on the identified use case and content type the switching module determines if to run the specific content from the mobile device or from the dongle associated with the remote screen. The determination is based on predefined rules considering the identified content type and use case or operation preformed by the user. For example video content may defined as to run on the dongle device, as the dongle device has better streaming capabilities. In case switching module determines to run the content from the dongle. The touch enabled device transmits the detail of the content and the application required for running the content. If the required application is not installed on the dongle device, the touch enabled device transmits the application binary data to the dongle, enabling to run the application on the dongle, or optionally the application identifying detail for installing the application on the dongle device.

The apparatus of the present invention may include, according to certain embodiments of the invention, machine readable memory containing or otherwise storing a program of instructions which, when executed by the machine, implements some or all of the apparatus, methods, features and functionalities of the invention shown and described herein. Alternatively or in addition, the apparatus of the present invention may include, according to certain embodiments of the invention, a program as above which may be written in any conventional programming language, and optionally a machine for executing the program such as but not limited to a general purpose computer which may optionally be configured or activated in accordance with the teachings of the present invention. Any of the teachings incorporated herein may wherever suitable operate on signals representative of physical objects or substances.

Unless specifically stated otherwise, as apparent from the following discussions, it is appreciated that throughout the specification discussions, utilizing terms such as, “processing”, “computing”, “estimating”, “selecting”, “ranking”, “grading”, “calculating”, “determining”, “generating”, “reassessing”, “classifying”, “generating”, “producing”, “stereo-matching”, “registering”, “detecting”, “associating”, “superimposing”, “obtaining” or the like, refer to the action and/or processes of a computer or computing system, or processor or similar electronic computing device, that manipulate and/or transform data represented as physical, such as electronic, quantities within the computing system's registers and/or memories, into other data similarly represented as physical quantities within the computing system's memories, registers or other such information storage, transmission or display devices. The term “computer” should be broadly construed to cover any kind of electronic device with data processing capabilities, including, by way of non-limiting example, personal computers, servers, computing system, communication devices, processors (e.g. digital signal processor (DSP), microcontrollers, field programmable gate array (FPGA), application specific integrated circuit (ASIC), etc.) and other electronic computing devices.

The present invention may be described, merely for clarity, in terms of terminology specific to particular programming languages, operating systems, browsers, system versions, individual products, and the like. It will be appreciated that this terminology is intended to convey general principles of operation clearly and briefly, by way of example, and is not intended to limit the scope of the invention to any particular programming language, operating system, browser, system version, or individual product.

It is appreciated that software components of the present invention including programs and data may, if desired, be implemented in ROM (read only memory) form including CD-ROMs, EPROMs and EEPROMs, or may be stored in any other suitable typically non-transitory computer-readable medium such as but not limited to disks of various kinds, cards of various kinds and RAMs. Components described herein as software may, alternatively, be implemented wholly or partly in hardware, if desired, using conventional techniques. Conversely, components described herein as hardware may, alternatively, be implemented wholly or partly in software, if desired, using conventional techniques.

Included in the scope of the present invention, inter alia, are electromagnetic signals carrying computer-readable instructions for performing any or all of the steps of any of the methods shown and described herein, in any suitable order; machine-readable instructions for performing any or all of the steps of any of the methods shown and described herein, in any suitable order; program storage devices readable by machine, tangibly embodying a program of instructions executable by the machine to perform any or all of the steps of any of the methods shown and described herein, in any suitable order; a computer program product comprising a computer useable medium having computer readable program code, such as executable code, having embodied therein, and/or including computer readable program code for performing, any or all of the steps of any of the methods shown and described herein, in any suitable order; any technical effects brought about by any or all of the steps of any of the methods shown and described herein, when performed in any suitable order; any suitable apparatus or device or combination of such, programmed to perform, alone or in combination, any or all of the steps of any of the methods shown and described herein, in any suitable order; electronic devices each including a processor and a cooperating input device and/or output device and operative to perform in software any steps shown and described herein; information storage devices or physical records, such as disks or hard drives, causing a computer or other device to be configured so as to carry out any or all of the steps of any of the methods shown and described herein, in any suitable order; a program pre-stored e.g. in memory or on an information network such as the Internet, before or after being downloaded, which embodies any or all of the steps of any of the methods shown and described herein, in any suitable order, and the method of uploading or downloading such, and a system including server/s and/or client/s for using such; and hardware which performs any or all of the steps of any of the methods shown and described herein, in any suitable order, either alone or in conjunction with software. Any computer-readable or machine-readable media described herein is intended to include non-transitory computer- or machine-readable media.

Any computations or other forms of analysis described herein may be performed by a suitable computerized method. Any step described herein may be computer-implemented. The invention shown and described herein may include (a) using a computerized method to identify a solution to any of the problems or for any of the objectives described herein, the solution optionally include at least one of a decision, an action, a product, a service or any other information described herein that impacts, in a positive manner, a problem or objectives described herein; and (b) outputting the solution.

The scope of the present invention is not limited to structures and functions specifically described herein and is also intended to include devices which have the capacity to yield a structure, or perform a function, described herein, such that even though users of the device may not use the capacity, they are, if they so desire, able to modify the device to obtain the structure or function.

Features of the present invention which are described in the context of separate embodiments may also be provided in combination in a single embodiment.

For example, a system embodiment is intended to include a corresponding process embodiment. Also, each system embodiment is intended to include a server-centered “view” or client centered “view”, or “view” from any other node of the system, of the entire functionality of the system, computer-readable medium, apparatus, including only those functionalities performed at that server or client or node.

What is claimed is:

1. A method for controlling apps activation within local network having at least one receiver module associated with external screen and at least one touch enabled device, both enabled to activate multimedia streaming applications, said method comprising the steps of:
selecting between at least one receiver module and at least one touch enabled device for activating multimedia application or content selected by a user, based on predefined rules or user instruction,
in case the selected device is not a mobile device having touched enabled screen:reverse mirroring of activated multimedia applications from the receiver module of the selected device to the touch enabled device through direct local wireless communication network and conveying input data from the touch enabled device in real-time to the receiver module of the selected device through direct local wireless communication network.

2. The method of claim 1 further comprising the step of transmitting the identification the multimedia content to be activated from touch enabled device to the receiver module.

3. The method of claim 1 further comprising the step of transmitting the identification the required multimedia application to be activated from touch enabled device to the receiver module.

4. The method of claim 1 further comprising the step of transmitting the multimedia application binary data to be activated from touch enabled device to the receiver module.

5. The method of claim 1 further comprising the step of installing the multimedia application on the receiver module.

6. The method of claim 1 further comprising the step of transmitting the identification the multimedia content to be activated from the receiver module to the touch enabled device.

7. The method of claim 1 further comprising the step of transmitting the identification of the required multimedia application to be activated from the receiver module to the touch enabled device.

8. The method of claim 1 further comprising the step of transmitting the multimedia application binary data to be activated from the receiver module to the touch enabled device.

9. The method of claim 1 wherein the predefined rules for selecting the available device for activating multimedia application, include checking video streaming quality.

10. The method of claim 1 wherein the predefined rules for selecting the available device for activating multimedia application, include identifying the use case of the application and the type of content.

11. A system for controlling apps activation within local network having at least one receiver module associated with external screen and at least one touch enabled device, both enabled to activate multimedia streaming applications, said system comprised of:
switching module for selecting between at least one receiver module and at least one touch enabled device for activating multimedia application or content selected by a user, based on predefined rules or user instruction,
wherein, in case the selected device is not a mobile device having touched enabled screen:activating mirroring module for reverse mirroring of activated multimedia applications from the receiver module of the selected device to the touch enabled device through direct local wireless communication network and conveying input data from the touch enabled device in real-time to the receiver module of the selected device through direct local wireless communication network.

12. The system of claim 11 wherein the switching further comprising the step of transmitting the identification the multimedia content to be activated from touch enabled device to the receiver module.

13. The system of claim 11 wherein the switching further comprising the step of transmitting the identification the required multimedia application to be activated from touch enabled device to the receiver module.

14. The system of claim 11 wherein the switching further comprising the step of transmitting the multimedia application binary data to be activated from touch enabled device to the receiver module.

15. The system of claim 11 wherein the switching further comprising the step of installing the multimedia application on the receiver module.

16. The system of claim 11 wherein the switching further comprising the step of transmitting the identification the multimedia content to be activated from the receiver module to the touch enabled device.

17. The system of claim 11 wherein the switching further comprising the step of transmitting the identification of the required multimedia application to be activated from the receiver module to the touch enabled device.

18. The system of claim 11 wherein the switching further comprising the step of transmitting the multimedia application binary data to be activated from the receiver module to the touch enabled device.

19. The system of claim 11 wherein the predefined rules for selecting the available device for activating multimedia application, include checking video streaming quality.

20. The system of claim 11 wherein the predefined rules for selecting the available device for activating multimedia application, include identifying the use case of the application and the type of content.
